(19) United States
(12) Patent Application Publication
(10) Pub. No.: US 2006/0285231 A1
(43) Pub. Date: Dec. 21, 2006

(54) Optical component and optical pickup device

(75) Inventors: Yoshihiro Kiyomura, Fukuoka (JP); Hitoshi Asahi, Kumamoto (JP); Noriaki Seki, Kumamoto (JP); Takatoshi Minoda, Kumamoto (JP); Eiji Okuzono, Fukuoka (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 11/438,685

(22) Filed: May 23, 2006

(30) Foreign Application Priority Data
May 24, 2005 (JP) P2005-150390
Jan. 18, 2006 (JP) P2006-009563

(51) Int. Cl. G02B 9/00

(52) U.S. Cl. 359/797

(57) ABSTRACT

The present invention relates to an optical component transmitting and/or reflecting light, which comprises at least two optical members and an adhesive layer bonding the optical members, said adhesive layer comprising a resin comprising a main chain having a siloxane bond as a repetition unit and a methyl group as a side chain. According to the optical component, it is possible to maintain its performance without deterioration of the adhesive layer, even when laser beams with high power are transmitted through and/or reflected by the adhesive layer.

### FIELD OF THE INVENTION

The present invention relates to an optical component having a function of transmitting and reflecting light and an optical pickup device using the optical component. More particularly, the present invention relates to an optical component which can be produced by bonding two or more optical members to each other and can employ short-wavelength laser beams with high power; and an optical pickup device employing the optical component.

### BACKGROUND OF THE INVENTION

In a conventional camera or an optical component such as an optical pickup, a variety of optical components such as complex lenses or complex prisms are constructed by bonding a plurality of optical elements such as lenses, as described in Patent Document 1. As described in Patent Document 2, there is an optical pickup employing the optical components, which is compatible with at least two kinds of optical recording mediums using beams with different wavelengths for recording and reproducing information. This optical pickup includes a first laser source emitting light with a relatively short wavelength, a first optical detector detecting reflected light with the relatively short wavelength, an objective lens for forming a ring-shaped blocking area between a paraxial area having a relatively small radius and an abaxial area having a relatively large radius, a laser unit emitting light with a relatively long wavelength and detecting only light passing through the paraxial area of the objective lens among the reflected light with the relatively large wavelength, and a plurality of beam splitters for directing the light emitted from the first laser source and the laser unit to the objective lens and directing the light reflected from the optical recording medium to any one of the first detector and the laser unit.

Patent Document 1: JP-A-2004-13061

Patent Document 2: JP-A-11-224436

### SUMMARY OF THE INVENTION

However, when the laser beams from the first laser source are irradiated to the beam splitters for a long time by using a UV laser or a blue laser as the first laser source of the conventional optical pickup device, the adhesive layer in which reflective surfaces having optical elements of the beam splitters thereon are bonded to each other cannot endure the energy density of the laser beams, and is colored or deformed to cause deterioration, thereby deteriorating performance of the beam splitters. The degree of deterioration becomes more remarkable in accordance with increase in energy density of the laser beams.

The present invention contrived to solve the above-mentioned problems. An object of the present invention is to provide an optical component in which an adhesive layer is not deteriorated and its performance is maintained even when laser beams with high power are transmitted and/or reflected by the adhesive layer; and an optical pickup device employing the optical component.

In order to accomplish the above-mentioned object, according to the present invention, there is provided the followings.
(1) An optical component which comprises:

at least two optical members; and

an adhesive layer bonding the optical members, said adhesive layer comprising a resin comprising a main chain having a siloxane bond as a repetition unit and a methyl group as a side chain,

said optical component transmitting and/or reflecting light.
(2) The optical component according to (1), wherein the resin has a trace of additive polymerization of hydrocarbon.
(3) The optical component according to (1), wherein the resin is cured through an additive polymerization reaction.
(4) The optical component according to (1), wherein the resin is subjected to a precision filtration and a defoamation, and is subsequently cured through an additive polymerization reaction.
(5) The optical component according to (4), wherein the resin is a resin from which particles having a diameter of 5 μm or more are removed through the precision filtration.
(6) An optical pickup device comprising:

a light source which emits light;

the optical component according to any one of (1) to (5); and

a light receiving element which receives light transmitted through or reflected by the optical component and reflected by an optical disk.
(7) An optical pickup device comprising:

a light source which emits light;

the optical component according to any one of (1) to (5); and

a light receiving element which receives light transmitted through and reflected by the optical component and reflected by an optical disk.
(8) The optical pickup device according to (6), wherein the optical component is a prism.
(9) The optical pickup device according to (7), wherein the optical component is a prism.
(10) The optical pickup device according to (6), wherein the optical component is a beam splitter.
(11) The optical pickup device according to (7), wherein the optical component is a beam splitter.
(12) A process for producing an optical component, which comprises:

disposing a resin comprising a main chain having a siloxane bond as a repetition unit and a methyl group as a side chain on at least one of at least two optical members; and

bonding the at least two optical members to each other with the resin.
(13) The process according to (12), wherein the at least two optical members are bonded to each other by curing the resin through an additive polymerization reaction.
(14) A process for producing an optical component, which comprises:

subjecting a resin comprising a main chain having a siloxane bond as a repetition unit and a methyl group as a side chain to a precision filtration and a defoamation;

disposing the resin on at least one of at least two optical members; and

bonding the at least two optical members to each other by curing the resin through an additive polymerization reaction.

According to the aspect of the invention, an adhesion property between the adhesive layer and the optical members can be enhanced, and the adhesive layer is not deteriorated even when laser beams with high power are transmitted and/or reflected by the adhesive layer, thereby maintain performance of the optical component.

### BRIEF DESCRIPTION OF THE DRAWINGS

FIG. 1 is a perspective view illustrating a complex lens according to an embodiment of the present invention.

FIG. 2 is a sectional view illustrating a complex lens according to an embodiment of the present invention.

FIG. 3 is a perspective view illustrating a complex prism according to an embodiment of the present invention.

FIG. 4 is a sectional view illustrating the complex prism according to an embodiment of the present invention.

FIG. 5 is a sectional view illustrating a test sample according to an embodiment of the present invention.

FIG. 6 is a sectional view illustrating another test sample according to an embodiment of the present invention.

FIG. 7 is a diagram schematically illustrating an exposure tester for estimating light resistance of an optical component according to an embodiment of the present invention.

FIG. 8 is a plane view illustrating an optical pickup device according to an embodiment of the present invention.

FIG. 9 is a lateral view illustrating the optical pickup device according to an embodiment of the present invention.

FIG. 10 is an enlarged plan view illustrating an integrated device according to an embodiment of the present invention.

### REFERENCE NUMERALS

1: EXPOSURE TEST SAMPLE

2: UV LASER GENERATOR

3: UV LASER BEAM

4: CONDENSING LENS

5: SLIT

6: CONDENSING LENS

7: SLIT

8: LIGHT RECEIVING ELEMENT

10A: COMPLEX LENS

20A: COMPLEX PRISM

30A, 30B: TEST SAMPLE

40: EXPOSURE TESTER

101, 102, 103, 104, 105, 106: OPTICAL MEMBER

201A, 202A, 203A, 204A: ADHESIVE LAYER

301, 302: OPTICAL GLASS

303, 306: ADHESIVE LAYER

304, 305: POTASSIUM BROMIDE SINGLE-CRYSTAL SUBSTRATE

401: OPTICAL DISK

402: SPINDLE MOTOR

403: OPTICAL PICKUP

404: CARRIAGE

405: OPTICAL PICKUP ACTUATOR

408, 410: INTEGRATED DEVICE

411, 414: COLLIMATING LENS

412: CRITICAL-ANGLE PRISM

413: BEAM SPLITTER

415: CONCAVE LENS

416: CONVEX LENS

417: RISING PRISM.

418, 419; OBJECTIVE LENS

481: BLUE-VIOLET LASER SOURCE

481a: LASER DIODE

482: LIGHT RECEIVING ELEMENT

483: PRISM

483b, 483c, 483d, 483e: OPTICAL MEMBER

483f, 483g, 483h: ADHESIVE LAYER

484: BLUE LASER BEAM

### DETAILED DESCRIPTION OF THE INVENTION

The followings will describe the present invention in detail.

First Embodiment

Hereinafter, an optical component and a process for producing the optical component according to a first embodiment of invention will be described in detail with reference to the drawings. However, the present invention is not limited to the embodiment.

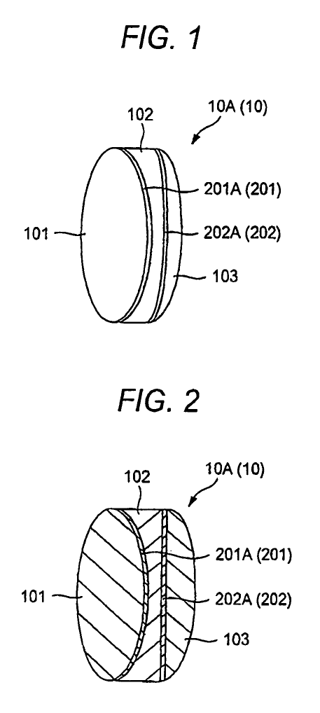

FIG. 1 is a perspective view illustrating a complex lens according to a first embodiment of the present invention and FIG. 2 is a sectional view illustrating the complex lens according to the first embodiment of the present invention.

In FIGS. 1 and 2, the complex lens 10A includes a plurality of, for example, three optical members 101, 102, and 103 made of a material transmitting light having a predetermined wavelength, and the optical members 101 to 103 are bonded to each other with adhesive layers 201A and 202A transmitting light having a predetermined wavelength.

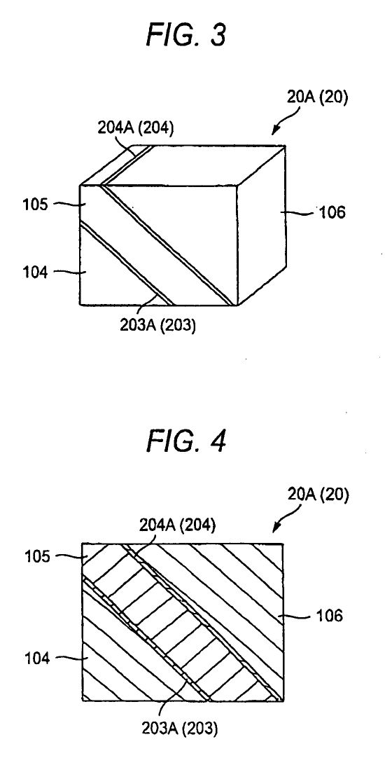

Furthermore, FIG. 3 is a perspective view illustrating a complex prism according to an embodiment of the present invention and FIG. 4 is a sectional view illustrating the complex prism according to the embodiment of the present invention. In FIGS. 3 and 4, the complex prism 20A includes a plurality of, for example, three optical members 104, 105, and 106 made of a material transmitting or reflecting light having a predetermined wavelength, and the optical members 104 to 106 are bonded to each other with adhesive layers 203A and 204A transmitting light having a predetermined wavelength.

The optical members 101 to 106 constituting the complex lens 10A and the complex prism 20A are made of a material transmitting or reflecting from violet to blue-violet light, such as quartz.

The adhesive layers 201A to 204A are formed of a cured material obtainable by curing a silicone resin including a main chain having a siloxane bond as a repetition unit and a methyl group as a side chain, which is shown in the following structure formula (I), preferably through an additive polymerization reaction of dimethylpolysiloxane as shown below (reaction formula (1)).

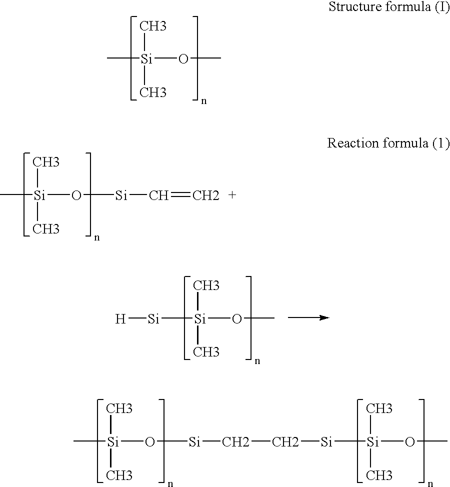

As shown in the reaction formula (1), polymers are formed through the additive polymerization reaction of a vinyl group (—CH═CH₂) and a hydroxyl group (H—Si—) at the ends of dimethylpolysiloxane. The polymers formed through the additive polymerization reaction do not generate byproducts, and the polymers are formed through an ethylene bond (—CH₂—CH₂—) between the molecules. Therefore, the resin has a trace of additive polymerization of hydrocarbon. Here, most of the main chains are substituted with a methyl group (—CH₃), but some may be substituted with hydrogen (—H).

Here, KE109A liquid manufactured by Shin-Etsu Chemical Co., Ltd. is used as the main agent of the curable resin and KE109B liquid manufactured by Shin-Etsu Chemical Co., Ltd. is used as the curing agent of the curable resin. The KE109A liquid and the KE109B liquid are respectively placed by 10 g in a beaker and are stirred and mixed with a glass rod. The adhesive layers 201A to 204A have such a property that they are less degenerated even by laser beams with high energy. Accordingly, by employing the adhesive layers 201A to 204A, the adhesion property with the optical members 101 to 106 can be enhanced and the adhesive layers are not degenerated even when UV laser beams with high power are transmitted and reflected by the adhesive layers, thereby keeping the characteristics of the complex lens 10A and the complex prism 20A, which are the optical components.

When the silicone resin is cured through the additive polymerization reaction, the silicone resin does not generate volatile components as byproducts. Accordingly, the adhesion property between the adhesive layers 201A to 204A and the optical members 101 to 106 can be enhanced, and deterioration of the uniformity of the adhesive layers 201A to 204A caused by the diffusion of the volatile components into the adhesive layers 201A to 204A can be prevented. The molecular weight of the silicone resin is preferably in the range of from 1,000 to 30,000, more preferably from 2,000 to 20,000, still more preferably from 5,000 to 15,000, and it is 10,000 here. The viscosity of the silicone resin is preferably in the range of from 0.05 Pa·s to 5 Pa·s, more preferably from 0.25 Pa·s to 2.5 Pa·s, still more preferably from 0.5 Pa·s to 2 Pa·s, and it is 1 Pa·s here. By using the silicone resin having the above-mentioned properties, excellent workability of dropping and compressing onto the optical members can be realized, and it is possible to form a thin adhesive layer having a enough adhesion strength without any influence to the optical characteristics.

The thickness of the adhesive layers 201A to 204A is preferably in the range of from 5 to 15 μm, and it is 10 μm here. When the thickness of the adhesive layers 201A to 204A is less than 5 μm, the adhesion of the optical members is not sufficient. When the thickness is greater than 15 μm, it affects the optical characteristics of the optical components.

In order to produce an optical component including the complex lens 10A and the complex prism 20A, a proper amount of silicone resin described above is applied or attached to at least one of the bonding surfaces of the optical components. Before disposing the silicone resin on the bonding surfaces of the optical members, 99.9% or more of the particles having a diameter of 5 μm or more existing in the silicone resin are removed by precision filtration. Furthermore, bubbles are removed from the filtered silicone resin. Here, a metal-sintered filter with excel pore NP gap of 5 μm manufactured by Nippon Seisen Co., Ltd. is used for the. precision filtration of the silicone resin. Furthermore, removal of the bubbles from the filtered silicone resin is carried out by using a defoaming stirring machine MS-50 manufactured by MATSUO SANGYO Co., LTD. The filtered and defoamed silicone resin is filled in an injector and is dropped on the optical members. Then, the silicone resin is spread on the bonding surfaces by pressing each of the optical members. In this state, by maintaining the optical members at a heating temperature of from 150 to 240° C. for a heating time of from 0.5 to 6 hours, it is possible to cure the silicone resin. Further, by curing the silicone resin under the above conditions, it is possible to form the adhesive layer having a sufficient adhesive strength. Here, the silicone resin is cured through the additive polymerization reaction by heating at a temperature of about 200° C. for 2 hours. Furthermore, before curing is carried out under the above heating conditions, the bonded optical members are preliminarily heated at about 150° C. for 1 hour. By performing the preliminary heating, it is possible to satisfactorily cure the silicone resin. In such a way, the adhesive layer is formed by curing the silicone resin, and thus it is possible to produce an optical component in which the optical members are bonded to each other with the adhesive layer.

As described above, the optical component may be produced by carrying out precision filtration and defoamation of the resin including a main chain having a siloxane bond as a repetition unit and a methyl group as a side chain, disposing the resin on at least one of the bonding surfaces of the optical members 101, 102 and 103, and bonding the optical members to each other by curing the resin through the additive polymerization reaction. In addition, the optical component may be produced by curing the resin including a main chain having a siloxane bond as a repetition unit and a methyl group as a side chain in advance to form a sheet or film, disposing the resin, for example, between the optical member 101 and the optical member 102, and bonding the optical members to each other by the use of a thermal pressing process.

Although explanations are described with referring to the complex lens and the complex prism as the example of the optical component, the present invention is not limited thereto, and may be applied to a variety of optical components such as a diffraction grating optical component, an optical filter, a polarized filter and a phase filter. In addition, the optical members constituting the optical component are not particularly limited, and optical members having a variety of shapes such as a plate shape, a block shape, and a substrate shape and a variety of sizes may be used.

Then, in order to develop a complex optical component which can be resistant to UV laser beams with high power to be transmitted and reflected, the inventors tried to manufacture optical components by using a variety of members constituting the optical components and a variety of adhesives for bonding the optical members to each other. Further, the inventors carried out a UV laser exposure test with high power to a variety of manufactured optical components. Thereafter, the inventors inspected the variation in composition of the adhesive layer by means of observation of the exposed surface, measurement of variation in UV transmittance, and measurement in UV spectrum transmittance of the adhesive layer as to exposure test samples. In addition, in order to estimate practicability of the manufactured optical components, the inventors performed estimations of the adhesion property of the adhesive layer and then found out an optical component which can be practically resistant to the UV laser with high power, thereby contriving an optical component and a process for producing the optical component according to the present invention.

In the process of contriving the present invention, a criterion of light resistance to be achieved is established so as to develop an optical component having resistance to a high-power ultraviolet laser beam. In addition, a bonded sample of the optical component is manufactured and is subjected to an exposure test. Hereinafter, the criterion of light resistance, the manufacture of the bonded sample, and the exposure test are described.

(1) Criterion of Light Resistance

First, in order to carry out a light resistance test of the optical component, the structure and shape of the test sample is determined. Substrates having a size of 4×4×2 mm³ are prepared out of an optical glass transmitting 99% of irradiated laser beams (other than reflected beams). The test sample is prepared by bonding 4×4 mm2 planes of two substrates to each other. The thickness of the adhesive layer is set in the range of from 5 to 15 μm.

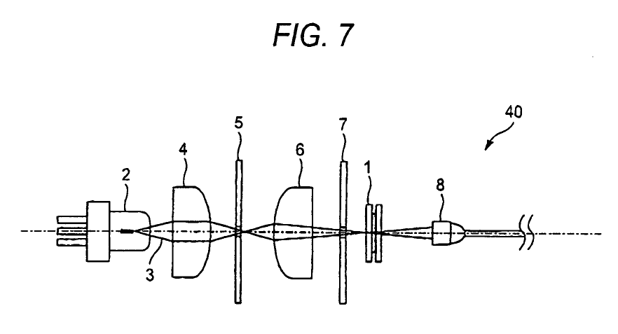

As the exposure tester shown in FIG. 7, an optical system is constructed so that ultraviolet layer beams 3 are perpendicularly incident on the bonding surface of exposure test sample 1. The incident ultraviolet layer beams 3 sequentially pass through the optical glass having a thickness of 2 mm, the adhesive layer having a thickness of from 5 to 15 μm, and the optical glass having a thickness of 2 mm in this order. The shape of the beams incident on the adhesive layer is set to a circle having a diameter φ of 0.3 mm and the power density of the ultraviolet laser beams is set to 5 mW/mm² or more.

The determination criterion for admission of light resistance of the test sample is that the ultraviolet laser beams are continuously irradiated for 3,000 hours or more under the above-mentioned conditions and the variation in the intensity of the laser beams passing through the test sample before and after carrying out the exposure test is 5% or less.

Further, as for the above-mentioned test sample, the adhesion strength of the adhesive layer constituting the test sample is measured before and after the exposure test. In measuring the adhesion strength of the test sample, a sample prepared by bonding and fixing metal members having hooks attached to optical glass surfaces (two 4×4 mm² opposed surfaces) of the test sample with an instantaneous adhesive is used as an adhesion strength test sample.

A tension test is performed using a tension tester. The hooks attached to the adhesion strength test sample are hooked on chucks of the tension tester and then the adhesion strength test samples are drawn vertically. The tension speed is set to 10 mm/min and force acting on the bonding surfaces of the adhesion strength test sample is measured. In this regard, the determination criterion for admission of adhesion is set to an adhesion strength of 1 kg/mm² or more.

(2) Manufacture of Bonded sample

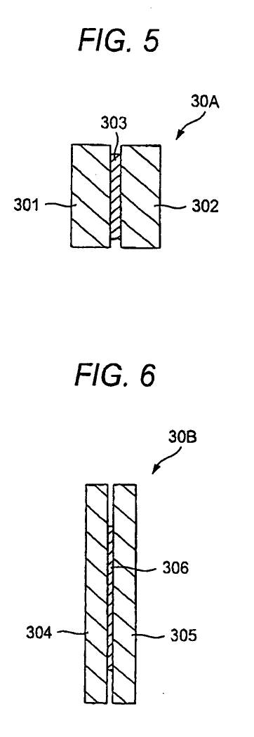

A test sample is manufactured to estimate the resistance of an adhesive used for manufacturing the optical component according to the present invention to the ultraviolet laser beams. FIGS. 5 and 6 are the sectional diagrams schematically illustrating the test samples 30A and 30B, respectively.

The test sample 30A shown in FIG. 5 is prepared by bonding optical glass plates (BK7) 301 and 302 having a size of 4×4×2 mm³ to each other with an adhesive layer 303. A proper amount of adhesive is applied at the time of bonding so that the thickness of the adhesive layer 303 is in the range of from 5 to 15 μm.

The test sample 30B shown in FIG. 6 is prepared by bonding potassium bromide single-crystal plates 304 and 305 having a diameter φ of 8 mm and a thickness of 1 mm to each other with an adhesive layer 306. A proper amount of adhesive is applied at the time of bonding so that the thickness of the adhesive layer 306 is in the range of from 5 to 15 μm.

The test sample 30A is used to estimate the variation in UV laser transmittance of the test sample in an exposure test to be described later. The variation in UV laser transmittance of the test sample is measured by the use of a power meter. The test sample 30B is used to estimate the variation in infrared spectroscopic transmittance of the test sample in the exposure test to be described later. The variation in infrared spectroscopic transmittance of the test sample is measured by using microscopic FTIR (Fourier Transform Infrared Spectroscopy).

Here, a process for producing the test samples 30A and 30B are described below. First, the optical glass plates (BK7) 301 and 302 and the potassium bromide single-crystal plates 304 and 305 are cleaned with isopropyl alcohol and toluene, followed by drying. The adhesives forming the adhesive layers 303 and 306 are filtered and defoamed so as to remove foreign substances such as dust or bubbles included in the adhesives. By bringing the adhesive attached to a needle end into contact with one surface of the optical glass (BK7) 301 which is cleaned and dried in the clean circumference where the foreign substances such as dust do not exist in the atmosphere, the adhesive is applied. The optical glass plate (BK7) 302 is placed on the surface of the optical glass plate 301 which is coated with the adhesive, and then the adhesive is spread.

Similarly, by bringing the adhesive attached to a needle end into contact with one surface of the potassium bromide single-crystal plate 304 which is cleaned and dried, the adhesive is applied. The potassium bromide single-crystal plate 305 is placed on the surface of the optical glass plate 304 which is coated with the adhesive, and then the adhesive is spread. Subsequently, the test samples 30A and 30B are dried in a dry oven so as to dry the adhesive. With regard to the dry conditions, temperature and time are set to the predetermined temperature and time necessary for drying the adhesives.

(3) Exposure Test

FIG. 7 is a diagram schematically illustrating an exposure tester used to estimate the light resistance of the optical component according to an embodiment of the present invention. In FIG. 7, a UV laser generator 2 in the exposure tester 40 has a laser diode generating laser beams with 405 nm, which is disposed in a sealed space.

In the first embodiment, a laser diode emitting blue-violet beams is used, but a laser diode emitting blue to violet beams may be optionally used. As the laser diode emitting laser beams with a short wavelength, a diode in which an active layer with the addition of an emission center such as In to GaN is interposed between a p type layer which contains GaN as a major component and is doped with p type impurities and an n type layer which contains GaN as a major component and is doped with n type impurities is preferably used. That is, a so-called nitride semiconductor laser is preferably used.

UV laser beams 3 emitted from a UV laser generator 2 advance with a width of a predetermined angle from the laser diode. The wide laser beams must be condensed in order to obtain laser beams with high power. Accordingly, the beams are condensed using a condensing lens 4. Next, in order to prepare a sectional shape which is perpendicular to the irradiation direction of the laser beams, the laser beams having a predetermined shape are obtained by allowing the laser beams to pass through-a pin hole or slit 5. The laser beams passing through the slit 5 and again widened are condensed by a condensing lens 6, and then guided to the exposure test sample 1.

At this time, a slit 7 is used to keep an area of the laser beams irradiated to the exposure test sample 1 to be constant. In this way, the sectional size of the laser beams irradiated to the exposure test sample 1 is set to a φ of about 300 μm. In the exposure test, the laser beams incident on the exposure test sample 1 and the laser beams passing through the exposure sample 1 are received by a light receiving element 8 and the intensities thereof are measured by using the power meter (not shown in Figs). The condensing lenses 4 and 6 used in the exposure tester 40 are made of quartz glass which is a material transmitting violet to blue-violet beams.

In accordance with (1) the criterion of light resistance, (2) the manufacture of a bonded sample, and (3) the exposure test, a sample of an optical component is manufactured and is estimated through the exposure test. Hereinafter, the optical component and the process for producing the optical component according to the present invention are described in more detail with reference to experimental examples and comparative examples.

### EXPERIMENTAL EXAMPLES

### Experimental Example 1

In Experimental Example 1, a specific silicone resin was used as an adhesive for bonding optical glass plates to construct an optical component. The silicone resin used in the present experimental example 1 is a resin which includes a main chain having a siloxane bond as a repetition unit and a methyl group as a side chain and is curable through an additive polymerization reaction. This silicone resin does not include volatile solvent in composition thereof and has a viscosity of about 1000 cps at 25° C. The above-mentioned silicone resin used for bonding the optical glass plates was filtered in advance by using a precision filter for removing particles having a diameter of 5 μm or more and bubbles were removed from the silicone resin.

In order to measure a variation in UV laser transmittance of a UV laser exposure test sample, an exposure test sample in which two optical glass plates (BK7) having a size of 4×4×2 mm³ were bonded was manufactured. Additionally, in order to measure a variation in UV spectroscopic transmittance of a UV laser exposure test sample, an exposure test sample in which two potassium bromide single-crystal plates having a diameter φ of 8 mm and a thickness of 1 mm were bonded was manufactured. Both exposure test samples were manufactured by bonding the test samples to each other with heating and curing the silicone resin by using an oven. At the time of heating and curing by using an oven, the test samples were preliminarily heated at 80° C. for 30 minutes and then were heated and cured at 200° C. for 120 minutes. The thickness of each adhesive layer after the heating and curing was 10 μm.

Subsequently, an UV laser irradiation test was performed to the exposure test samples. The UV laser beams were continuously irradiated to the test samples with power densities of 5 mW/mm², 50 mW/mm², and 300 mW/mm² for 3000 hours. Then, the variations in UV laser transmittance of the test samples for measuring the variation in UV laser transmittance, which were exposed to the UV laser beams with power densities of 5 mW, mm², 50 mW/mm², and 300 mW/mm², were measured. As a result, the variation in transmittance of each test sample was 2% or less with respect to the transmittance before performing the exposure test.

Then, variations in transmittance in a wavelength range of from 2.5 μm to 25 μm of the test samples for measuring a variation in infrared spectroscopic transmittance, which were exposed to the UV laser beams with power densities of 5 mW/mm², 50 mW/mm², and 300 mW/mm², were measured by using a microscopic FTIR. As a result, no variation in transmittance of each test sample was observed with respect to the transmittance before performing the exposure test. The measurement of the infrared spectroscopic transmittance was performed by using the microscopic FTIR manufactured by Nicole Corporation, under the conditions with an analysis area of 100 μm×100μm, a transmissive mode, a resolution of 4 cm⁻¹, and scan times of 100 times.

Adhesion strength of the test sample for measuring the variation in UV laser transmittance, which were exposed to the UV laser beams with power densities of 5 mW/mm², 50 mW/mm², and 300 mW/mm², was measured. As a result, no deformation and peeling of the adhesive layer occurred even when a tension load of 1.5 Kg/mm² was applied with a tension tester.

According to the above-mentioned configuration of Experimental Example 1 described above, even when the UV laser beams with high power is used, the adhesive layer constituting the optical component is not degenerated and thus the performance of the optical component can be maintained. Accordingly, it is possible to provide an optical component having light resistance even when an optical system using the UV laser beams with high power is constructed.

### Comparative Example 1

In Comparative Example 1, a UV curable acrylic resin was used as a conventional adhesive for bonding optical glass plates. The acrylic resin used in Comparative Example 1 is OP-1030M manufactured by Denki Kagaku Kogyo Kabushiki Kaisha. This acrylic resin does not include volatile solvent in the composition thereof and has a viscosity of about 500 cps at 25° C. The acrylic resin used for bonding the optical glass plates was filtered in advance by using a precision filter for removing particles having a diameter of 5 μm or more and bubbles were removed from the acrylic resin.

In order to measure a variation in UV laser transmittance of an UV laser exposure test sample, an exposure test sample in which two sheets of optical glass plates (BK7) having a size of 4×4×2 mm³ were bonded was manufactured. Additionally, in order to measure a variation in UV spectroscopic transmittance of an UV laser exposure test sample, an exposure test sample in which two potassium bromide single-crystal plates having a diameter φ of 8 mm and a thickness of 1 mm were bonded was manufactured. Both exposure test samples were manufactured by bonding the test samples to each other with curing the above-mentioned acrylic resin by using an UV irradiating apparatus. An UV irradiating apparatus manufactured by Ushio Inc. was used as the UV irradiating apparatus and the amount of exposure was set to 1000 mJ/cm². The thickness of each adhesive layer after curing the acryl resin was 8 μm.

Subsequently, an UV laser irradiation test was performed to the exposure test samples. The UV laser beams were continuously irradiated to the test samples with power densities of 5 mW/mm², 50 mW/mm², and 300 mW/mm². Then, a variations in UV laser transmittance of the test samples for measuring the variation in UV laser transmittance, which were exposed to the UV laser beams with power densities of 5 mW/mm², 50 mW/mm², and 300 mW/mm², were measured. As a result, the variation in transmittance of each test sample was 50% or more within 100 hours for continuous irradiation of the UV laser beams, and thus the irradiation test was stopped.

### Comparative Example 2

In Comparative Example 2, an UV curable silicone resin was used as a conventional adhesive for bonding optical glass plates. The silicone resin used in Comparative Example 2 is E3213 manufactured by NTT Advanced Technology Corporation. This silicone resin does not include volatile solvent in the composition thereof. The silicone resin used for bonding the optical glass plates was filtered in advance by using a precision filter for removing particles having a diameter of 5 μm or more and bubbles were removed from the silicone resin.

In order to measure a variation in UV laser transmittance of a UV laser exposure test sample, an exposure test sample in which two optical glass plates (BK7) having a size of 4×4×2 mm³ were bonded was manufactured. In order to measure a variation in UV spectroscopic transmittance of an UV laser exposure test sample, an exposure test sample in which two potassium bromide single-crystal plates having a diameter φ of 8 mm and a thickness of 1 mm were bonded was manufactured. Both exposure test samples were manufactured by bonding the test samples to each other with curing the above-mentioned silicone resin by using a UV irradiating apparatus. An UV irradiating apparatus manufactured by Ushio Inc. was used as the UV irradiating apparatus and the amount of exposure was set to 1000 mJ/cm². The thickness of each adhesive layer after curing the silicone resin was 8 μm.

Next, an UV laser irradiation test was performed to the exposure test samples. The UV laser beams were continuously irradiated to the test samples with power densities of 5 mW/mm², 50 mW/mm², and 300 mW/mm². Then, variations in UV laser transmittance of the test samples for measuring the variation in UV laser transmittance, which were exposed to the UV laser beams with power densities of 5 mW/mm², 50 mW/mm², and 300 mW/mm², were measured. As a result, the product exposed with a power density of 5 mW/mm² exhibited a variation in transmittance of 50% or more by the continuous irradiation of the UV laser beams for 1000 hours, and the product exposed with a power density of 50 mW/mm² exhibited a variation in transmittance of 50% or more by the continuous irradiation. of the UV laser beams for 500 hours. In addition, the product exposed with a power density of 300 mW/mm² exhibited a variation in transmittance of 50% or more by the continuous irradiation of the UV laser beams for 100 hours, and thus the irradiation test was stopped.

### Comparative Example 3

In Comparative Example 3, a heat-curable silicone resin was used as a conventional adhesive for bonding optical glass plates. The silicone resin used in Comparative Example 3 is Glass resin GR-1000 manufactured by Showa Denko Kabushiki Kaisha, and a sample in which 30 wt% of powder resin was dissolved in toluene was used. The silicone resin used for bonding the optical glass plates was filtered in advance by using a precision filter for removing particles having a diameter of 5 μm or more and bubbles were removed from the silicone resin.

In order to measure a variation in UV laser transmittance of a UV laser exposure test sample, an exposure test sample in which two optical glass plates (BK7) having a size of 4×4×2 mm³ were bonded was manufactured. Additionally, in order to measure a variation in UV spectroscopic transmittance of an UV laser exposure test sample, an exposure test sample in which two potassium bromide single-crystal plates having a diameter φ of 8 mm and a thickness of 1 mm were bonded was manufactured. Both exposure test samples were manufactured by bonding the test samples to each other with heating and curing the above-mentioned silicone resin by using an oven. At the time of manufacturing the test samples, the silicone resin was first applied to one surface of one optical glass plate, the optical glass plate was preliminarily heated at 80° C. for 60 minutes to volatilize solvent from the resin, the other optical glass plate was bonded thereto, and then the optical glass plates were heated and cured at 180° C. for 60 minutes. The thickness of each adhesive layer after curing the resin was 15 μm.

The adhesion strength of the test sample was measured. As a result, when a tension load of 0.05 Kg/mm² is applied with a tension tester, the optical glass plate and the adhesive layer were peeled at the boundary therebetween, and thus the subsequent test was stopped.

### Comparative Example 4

In Comparative Example 4, a heat-curable silicone resin was used. This silicone resin is a resin which includes a main chain having a siloxane bond as a repetition unit and a methyl group and a phenyl group as a side chain, and is curable through an additive polymerization reaction. This silicone resin does not include volatile solvent in the composition thereof and has a viscosity of about 3000 cps at 25° C. The silicone resin used for bonding the optical glass plates was filtered in advance by using a precision filter for removing particles having a diameter of 5 μm or more and bubbles were removed from the silicone resin.

In order to measure a variation in UV laser transmittance of a UV laser exposure test sample, an exposure test sample in which two optical glass plates (BK7) having a size of 4×4×2 mm³ were bonded was manufactured. Additionally, in order to measure a variation in UV spectroscopic transmittance of a UV laser exposure test sample, an exposure test sample in which two potassium bromide single-crystal plates having a diameter φ of 8 mm and a thickness of 1 mm were bonded was manufactured. Both exposure test samples were manufactured by bonding the test samples to each other with heating and curing the above-mentioned silicone resin by using an oven. The thickness of each adhesive layer after curing the silicone resin was 15 μm.

Subsequently, an UV laser irradiation test was performed to the exposure test samples. The UV laser beams were continuously irradiated to the test samples with power densities of 5 mW/mm², 50 mW/mm², and 300 mW/mm². Then, variations in UV laser transmittance of the test samples for measuring the variation in UV laser transmittance, which were exposed to the UV laser beams with power densities of 5 mW/mm², 50 mW/mm², and 300 mW/mm², were measured. As a result, the product exposed with a power density of 5 mW/mm² exhibited a variation in transmittance of 50% or more by continuous irradiation of the U laser beams for 400 hours, and the product exposed with a power density of 50 mW/mm² exhibited a variation in transmittance of 50% or more by continuous irradiation of the UV laser beams for 100 hours. The product exposed with a power density of 300 mW/mm² exhibited a variation in transmittance of 50% or more by continuous irradiation of the UV laser beams for 70 hours, and thus the irradiation test was stopped.

Second Embodiment

Next, an example of an optical pickup device employing the optical component according to the first embodiment will be described.

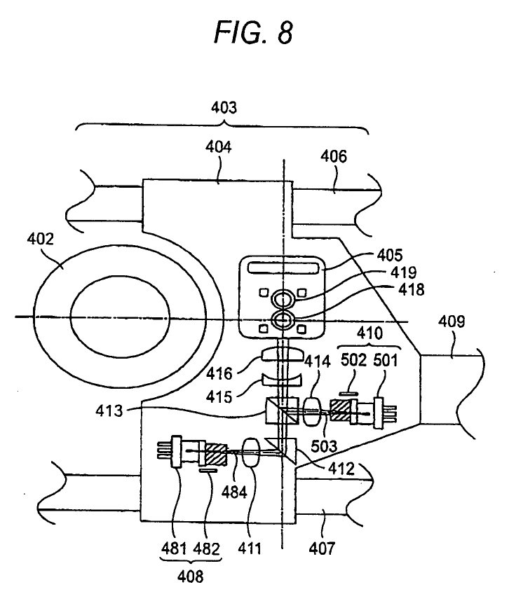

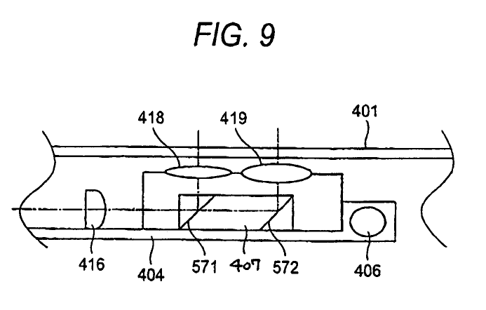

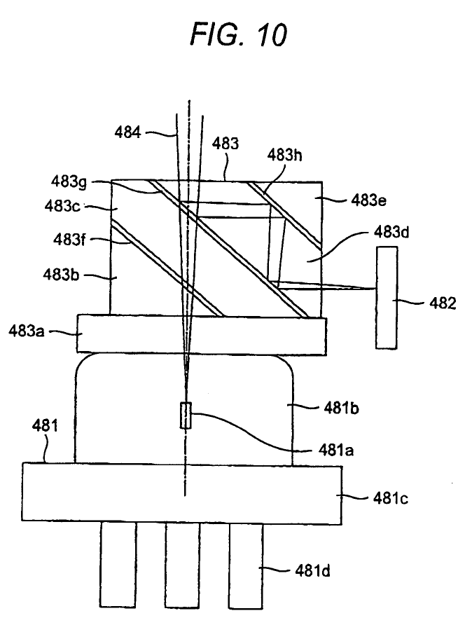

FIG. 8 is a front view illustrating an optical pickup device according to a second embodiment of the present invention, FIG. 9 is a side view thereof, and FIG. 10 is a plan view illustrating an integrated device 408 according to an embodiment of the invention.

In FIGS. 8 and 9, reference numeral 401 indicates an optical disk, which can perform at least one function of writing data or reading the written data by irradiating a laser beam thereto. Examples of the optical disk 401 which can perform only the reading of data include a CD-ROM disk and a DVD-ROM disk, examples of the optical disk which can perform the writing and reading of data include a CD-R disk and a DVD-R disk, and examples of the optical disk which can perform the reading of data and the writing and erasing of data include a CD-RW disk and a DVD-RW disk.

Examples of the optical disk 401 include an optical disk having a recording layer which can perform at least one of the writing and the reading of data by a red beam, an optical disk having a recording layer which can perform the writing and the reading of data by a infrared beam, and an optical disk having a recording layer which can perform the writing and the reading of data by blue to blue-violet beams. The optical disk 401 may have a variety of diameters, and preferably a diameter of from 3 to 12 cm.

Reference numeral 402 indicates a spindle motor for rotating the optical disk 401. Although it is not shown in Figs., the spindle motor 402 includes a damper for clamping the optical disk 401. The spindle motor 402 can rotate the optical disk 401 at a constant angular velocity or at a variable angular velocity.

Reference numeral 403 indicates an optical pickup for writing or reading data of the optical disk 401 by irradiating laser beams to the optical disk 401, reference numeral 404 indicates a carriage for moving the optical pickup 403, and reference numeral 405 indicates an optical pickup actuator for three-dimensionally moving objective lenses 418 and 419 of the optical pickup 403.

The carriage 404 is supported by at least a support shaft 406 and a guide shaft 407, and is movable in the diameter direction between the inner circumference and the outer circumference of the optical disk 401. The carriage 404 includes an optical pickup actuator 405, a blue-violet laser source 481 to be described later, and an optical system for guiding the laser beams from the blue-violet laser source 481 to the optical pickup actuator 405, and is connected to a laser flexible substrate 409 by means of soldering attachment.

Reference numeral 408 indicates an integrated device including the blue-violet laser source 481 and a light receiving element 482, and the details thereof are described later with reference to FIG. 10. Reference numeral 410 indicates an integrated element including a red and infrared laser source 501 and a light receiving element 502. Although the red and infrared laser source 501 is not shown in Figs., it includes a laser diode 481a emitting a red laser beam having a wavelength of about 660 nm and a laser diode 481a emitting an infrared laser beam having a wavelength of about 780 nm. The laser diodes are sealed.

Next, the optical system is described. Reference numeral 411 indicates a collimating lens for a laser beam having a wavelength of 405 nm and serves to convert a blue laser beam 484 emitted from the blue-violet laser source 481 into a parallel beam. The collimating lens 411 has a function of correcting chromatic aberration of the laser beam generated due to variation in wavelength and variation in temperature. Reference numeral 412 indicates a critical-angle prism, which serves to split the blue laser beam 484.

Reference numeral 413 indicates a beam splitter, which serves to split and condense (couple) the blue laser beams 484 and the laser beams 503 emitted from the blue-violet laser source 481 and the red and infrared laser source 501. Reference numeral 414 indicates a collimating lens for laser beams having wavelengths of 660 nm and 780 nm, which serves to convert the laser beams 503 emitted from the red and infrared laser source 501 into parallel beams. The collimating lens may have a function of correcting chromatic aberration of the laser beams generated due to variation in wavelength and variation in temperature.

Reference numeral 415 indicates a concave lens having a negative power and reference numeral 416 indicates a convex lens having a positive power. By combining the concave lens 415 and the convex lens 416, the blue laser beams 484 and the laser beams 503 can be enlarged to a desired diameter. Reference numeral 417 (see FIG. 9) indicates an upward-reflecting prism, and a dielectric multi-layered film having functions of reflecting the laser beams 503 having wavelengths of 660 nm and 780 nm and transmitting the laser beams having a wavelength of 405 nm is formed on a first prism plane 571. A second prism plane 572 serves to reflect the laser beams having a wavelength of 405 nm.

Reference numeral 418 indicates an objective lens accepting the laser beams for DVD having a wavelength of 660 nm, which can convert the laser beams for CD having a wavelength of 780 nm into parallel beams to focus on a point at the position of a writing height. Reference numeral 419 indicates an objective lens for the optical disk 401 (Blue-Ray or AOD) accepting the laser beams having a wavelength of 405 nm.

In this embodiment, as shown in FIG. 8, the objective lens 418 is disposed at the center of the spindle motor 402, and the objective lens 419 is disposed on the opposite side of the convex lens 416 with the objective lens 418 disposed therebetween, that is, in a tangential direction to the optical disk 401. The thickness of the objective lens 419 is larger than that of the objective lens 418.

As shown in FIG. 9, beams having a relatively long wavelength among the beams emitted from the light source are upwardly reflected by the first prism plane 571, and beams having a relatively short wavelength passes through the first prism plane 571 and are upwardly reflected by the second prism plane 572. Accordingly, the circulation path of the laser beams until the laser beams are incident on the upward-reflecting prism 417 can be relatively elongated, thereby facilitating optical design.

As shown in FIG. 10, the blue-violet laser source 481 includes the laser diode 481a emitting a laser beam having a wavelength of 405 nm. The laser diode 481a is disposed in an enclosed space surrounded with a base 481c and a cover 481b.

The laser diode 481a emitting a blue-violet laser beam is used in this Embodiment, but a laser diode emitting blue to violet laser beams may be optionally used. As the laser diode emitting laser beams with a short wavelength, a diode in which an active layer with the addition of an emission center such as In to GaN is interposed between a p type layer which contains GaN as a major component and is doped with p type impurities and an n type layer which contains GaN as a major component and is doped with n type impurities is preferably used. That is, a so-called nitride semiconductor laser is preferably used.

A plurality of terminals 481d including an earth terminal and a power supply terminal is disposed in the base 481c. A transparent window (not shown in Figs.) for inputting and outputting the blue laser beams 484 is disposed in the cover 481b. Reference numeral 483 indicates a prism attached to the transparent window of the cover 481b by means of attachment. The prism 483 transmits the blue laser beams 484 emitted from the laser diode 481aonto the optical disk 401 and guides the reflected laser beams from the optical disk 401 to the light receiving element 482. The prism 483 also constitutes the above-described optical system.

A diffraction grating (not shown in Figs.) for monitoring the blue laser beams 484 is disposed in the prism 483, and a diffraction grating (not shown in Figs.) for splitting the blue laser beams 484 having a wavelength of 405 nm is disposed at a position where the blue laser beams 484 are guided to the light receiving element 482. The detection of focus, the detection of tracking, the detection of spherical aberration, the detection of signals recorded by the optical disk 401, and the detection of control signals can be performed by the light receiving element 482.

In this Embodiment, the prism 483 is disposed on the blue-violet laser source 481 with a transparent cover member 483a disposed therebetween. The prism 483 includes optical members 483b, 483c, 483d, and 483e having slope planes which are parallel to each other and adhesive layers 483f, 483g, and 483h for bonding the optical members to each other.

A quartz plate or an optical glass plate transmitting the violet to blue-violet laser beams 484 is used as the optical members 483b to 483e. An optical element such as a beam splitter film or a hologram film is disposed on the slope planes of the optical members 483b to 483e, thereby constituting an integrated element 408 in which the optical members 483b to 483e transmit and/or reflect the blue laser beams 484 and the light receiving element 482 detects the blue laser beams.

### EXPERIMENTAL EXAMPLES

### Experimental Examples 2

Since the adhesive layers 483f, 483g, and 483h transmit or reflect the blue laser beams 484, it is necessary to use an adhesive having UV resistance. In Experimental Examples 2, a curable resin which includes a main chain having a siloxane bond as a repetition unit and a methyl group as a side chain and is curable through an additive polymerization reaction was used in the adhesive layer 483f, 483g, and 483h. This curable resin does not include volatile solvent in the composition thereof. Before performing the bonding, the curable resin was filtered to remove particles having a diameter of 5 μm or more and bubbles were removed from the curable resin. The thickness of each of the adhesive layers 483f, 483g, and 483h in the manufactured prism 483 was 15 μm.

A blue laser irradiation test was performed to the optical pickup device employing the above-described prism 483. When the blue laser beams 484 irradiated to the prism 483 from the blue-violet laser source 481 were incident on the adhesive layer 483f, the size (diameter) of the exposure plane φ was about 300 μm and the power density was about 300 mW/mm². When the blue laser beams were incident on the adhesive layer 483g, the size (diameter) of the exposure plane φ was about 500 μm and the power density was about 100 mW/mm². When the blue laser beams were incident on the adhesive layer 483h, the size (diameter) of the exposure plane φ was about 300 μm and the power density was about 5 mW/mm².

The power densities were calculated from the measured value of the power density of the blue laser beams 484 emitted from the blue-violet laser source 481, the measured value of the power density of the blue laser beams 484 passing through the prism 483, the measured value of the power density of the blue laser beams 484 measured by the light receiving element 482, and the size of the exposure plane of the blue laser beams 484 incident on each adhesive layer 483f, 483g, and 483h.

The irradiation of the blue laser beams 484 was performed continuously for 3000 hours and the variation in light density was measured by the light receiving element 482. As a result of the blue laser irradiation test, it has proved that the decrease in light intensity measured by the light receiving element 482 was 5% or less and it is confirmed that the optical pickup device according to Experimental example 2 can be used practically.

As described above, according to Experimental example 2, even when the blue laser beams 484 are irradiated, the adhesive layers 483f, 483g, and 483h of the prism 483 are not degenerated and thus the performance of the prism 483 can be maintained. Accordingly, it is possible to obtain an optical pickup device having UV resistance and high practicability. The curable resin described above can be also used as the adhesive of the beam splitter 413 and the upward-reflecting prism 417.

### Comparative Example 5

Next, a blue laser irradiation test was performed to the conventional UV curable acrylic resin used for bonding the optical glass plates for the purpose of comparison with Experimental example 2. The acrylic resin used in this Comparative Example 5 is OP-1030M manufactured by Denki Kagaku Kogyo Kabushiki Kaisha, and this acrylic resin does not include volatile solvent in the composition thereof, and has a viscosity of about 500 cps at 25° C. Before performing the bonding, the acrylic resin was filtered by using a precision filter for removing particles having a diameter of 5 μm or more and bubbles were removed from the acryl resin.

An exposure test sample was manufactured by bonding the optical members 483b to 483e with the adhesive and curing the adhesive by means of irradiation of UV using an UV irradiating apparatus. An UV irradiating apparatus manufactured by Ushio Inc. was used as the UV irradiating apparatus and the amount of exposure was 1000 mJ/cm². The thickness of each adhesive layer 483f, 483g, and 483h after curing the adhesive was 8 μm.

The blue laser beams 484 were irradiated continuously, and the variation of the light intensity with time was measured by the light receiving element 482. Fifty hours after the test is started, the light intensity measured by the light receiving element 482 was decreased by 50% or less, and thus the test was stopped.

### Comparative Example 6

Next, a blue laser irradiation test was performed to the conventional UV curable silicone resin which is an adhesive used for bonding the optical glass plates. The silicone resin used in Comparative Example 6 is E3213 manufactured by NTT Advanced Technology Corporation, which does not include volatile solvent in the composition thereof. Before performing the bonding, the silicone resin was filtered by using a precision filter for removing particles having a diameter of 5 μm or more and bubbles were removed from the silicone resin.

An exposure test sample was manufactured by bonding the optical members 483b to 483e with the adhesive and curing the adhesive by means of irradiation of UV using an UV irradiating apparatus. An UV irradiating apparatus made by Ushio Inc. was used as the UV irradiating apparatus and the amount of exposure was 1000 mJ/cm². The thickness of each adhesive layer 483f, 483g, and 483h after curing the adhesive was 8 μm.

The blue laser beams 484 were irradiated continuously, and the variation with time of the light intensity was measured by the light receiving element 482. Two hundred hours after the test is started, the light intensity measured by the light receiving element 482 was decreased to 50% or less, and thus the test was stopped.

### Comparative Example 7

Next, a blue laser irradiation test was performed to the conventional heat-curable silicone resin which is an adhesive used for bonding the optical glass plates. The silicone resin used in Comparative Example 7 is GR-100 manufactured by Showa Denko Kabushiki Kaisha, and a sample in which 30 wt % of powder resin was dissolved in toluene was used. Before performing the bonding, the silicone resin was filtered by using a precision filter for removing particles having a diameter of 5 μm or more and bubbles were removed from the silicone resin.

An exposure test sample was manufactured by bonding the optical members 483b to 483e with the adhesive and heating and curing the adhesive by using an oven. At the time of manufacturing the test sample, the silicone resin was first applied to one surface of one optical members 483b to 483e, the optical members were preliminarily heated at 80° C. for 60 minutes to volatilize solvent from the resin, other optical members were bonded thereto, and then the optical members were heated and cured at 180° C. for 60 minutes.

A prism was manufactured by sequentially performing the above-mentioned processes to the optical members 483b and 483c, the optical members 483b and 483c bonded to each other and the optical member 483d, the optical members 483b, 483c, and 483d and the optical member 483e. The thickness of each adhesive layer 483f, 483g, and 483h after curing the adhesive was 15 μm.

In the test sample manufactured as described above, the adhesive had a small adhesion strength, the bonding surface was peeled off at the time of handling the prism 483, and thus the test was stopped.

### Comparative Example 8

Next, a blue laser irradiation test was performed to another heat-curable silicone resin. This silicone resin used in Comparative Example 8 is a resin which includes a main chain having a siloxane bond as a repetition unit and a methyl group and a phenyl group as a side chain, and is curable through an additive polymerization reaction. This silicone resin does not include volatile solvent in the composition thereof and has a viscosity of about 3000 cps at 25° C. Before performing the bonding, the silicone resin used for bonding the optical glass plates was filtered by using a precision filter for removing particles having a diameter of 5 μm or more and bubbles were removed from the silicone resin.

An exposure test sample was manufactured by bonding the optical members 483b to 483e with the adhesive and heating and curing the adhesive by using an oven. At the time of manufacturing the test sample, the silicone resin was first applied to a bonding surface of the optical member 483b and the optical member 483c was bonded thereto. The silicone resin was applied to a bonding surface of the optical member 483d and the optical member 483e was bonded thereto. The optical members bonded in this way was heated and cured at 150° C. for 4 hours by using an oven. The thickness of each adhesive layer 483f, 483g, and 483h after curing the adhesive was 15 μm.

The blue laser beams 484 were irradiated continuously, and the variation with time of the light intensity was measured by the light receiving element 482. Six hundred hours after the test was started, the light intensity measured by the light receiving element 482 was decreased to 50% or less, and thus the test was stopped.

Since the optical component according to the present invention has a resistance to short-wavelength laser beams with high power, it can be used as optical components used in an optical system for transmitting and reflecting laser beams.

While the present invention has been described in detail and with reference to specific embodiments thereof, it will be apparent to one skilled in the art that various changes and modifications can be made therein without departing from the scope thereof.

This application is based on Japanese patent application No. 2005-150390 filed May 24, 2005 and Japanese patent application No. 2006-009563 filed Jan. 18, 2006, the entire contents thereof being hereby incorporated by reference.

1. An optical component which comprises:
at least two optical members; and
an adhesive layer bonding the optical members, said adhesive layer comprising a resin comprising a main chain having a siloxane bond as a repetition unit and a methyl group as a side chain,
said optical component transmitting and/or reflecting light.

2. The optical component according to claim 1, wherein the resin has a trace of additive polymerization of hydrocarbon.

3. The optical component according to claim 1, wherein the resin is cured through an additive polymerization reaction.

4. The optical component according to claim 1, wherein the resin is subjected to a precision filtration and a defoamation, and is subsequently cured through an additive polymerization reaction.

5. The optical component according to claim 4, wherein the resin is a resin from which particles having a diameter of 5 μm or more are removed through the precision filtration.

6. An optical pickup device comprising: a light source which emits light;
the optical component according to claim 1; and
a light receiving element which receives light transmitted through or reflected by the optical component and reflected by an optical disk.

7. An optical pickup device comprising: a light source which emits light;
the optical component according to claim 1; and
a light receiving element which receives light transmitted through and reflected by the optical component and reflected by an optical disk.

8. The optical pickup device according to claim 6, wherein the optical component is a prism.

9. The optical pickup device according to claim 7, wherein the optical component is a prism.

10. The optical pickup device according to claim 6, wherein the optical component is a beam splitter.

11. The optical pickup device according to claim 7, wherein the optical component is a beam splitter.

12. A process for producing an optical component, which comprises:
disposing a resin comprising a main chain having a siloxane bond as a repetition unit and a methyl group as a side chain on at least one of at least two optical members; and
bonding the at least two optical members to each other with the resin.

13. The process according to claim 12, wherein the at least two optical members are bonded to each other by curing the resin through an additive polymerization reaction.

14. A process for producing an optical component, which comprises:
subjecting a resin comprising a main chain having a siloxane bond as a repetition unit and a methyl group as a side chain to a precision filtration and a defoamation;
disposing the resin on at least one of at least two optical members; and
bonding the at least two optical members to each other by curing the resin through an additive polymerization reaction.
